(19) United States
(12) Patent Application Publication
(10) Pub. No.: US 2022/0040508 A1
(43) Pub. Date: Feb. 10, 2022

(54) WEARABLE AIR CLEANING DEVICE

(71) Applicant: University of Maryland, College Park, College Park, MD (US)

(72) Inventors: Jelena SREBRIC, Takoma Park, MD (US); Avery LAYNE, Upper Marlboro, MD (US); Nicholas W. MATTISE, Washington, DC (US); Shengwei ZHU, Ellicott City, MD (US); Sebastian ROMO, College Park, MD (US); Lingzhe WANG, Greenbelt, MD (US)

(21) Appl. No.: 17/395,399

(22) Filed: Aug. 5, 2021

Related U.S. Application Data
(60) Provisional application No. 63/061,582, filed on Aug. 5, 2020.

(51) Int. Cl. A62B 18/08; A62B 18/00; A62B 7/10

(52) U.S. Cl. CPC A62B 18/08; A62B 7/10; A62B 18/006; A62B 18/003

(57) ABSTRACT

Filtered, clean air can be provided via a personalized airflow to a user, to reduce inhalation of unwanted particles, bioaerosoles, and the like, while providing greater comfort than passive PPE. Various systems and methods are disclosed herein, for filtering and cleaning air via a smart, wearable device. For example, a headset in accordance with this disclosure can detect unwanted particulate matter, harmful compounds, bioaerosols, and other ambient conditions, and dynamically adjust an airflow to form an airshield that is distributed over a user's nose and mouth so as to reduce inhalation of contaminated air by as much as 70%. Various embodiments may utilize filters, disinfection modules, pressure sensors, movement sensors, ambient sensors, and contaminant sensors housed within wearable, portable devices.

### CROSS-REFERENCES TO RELATED APPLICATIONS

This application claims the benefit and priority of U.S. Provisional Application No. 63/061,582, filed on Aug. 5, 2020, which hereby is incorporated herein by reference in its entirety.

### STATEMENT REGARDING FEDERALLY SPONSORED RESEARCH

This invention was made with government support under grant number 304758-00001 awarded by the Centers for Disease Control and Prevention. The government has certain rights in the invention.

### TECHNICAL FIELD

This disclosure generally relates to the field of air cleaning. More specifically, examples of the present disclosure describe various aspects of personal air filtration and disinfection devices for removing airborne contaminants (e.g., viruses, bio-aerosols, volatile organic compounds, ozone, and other pollutants or contaminants), which can be worn by a user to provide greater mobility and convenience, and which can check for contaminants, passively filter and actively disinfect contaminants, and provide clean air in a targeted fashion to protect respiratory health.

### BACKGROUND

Airborne contaminants present a significant risk to respiratory health. These contaminants can take many forms and sizes, including nuisance particles (e.g., wood dust, smoke, etc.) as well as small, aerosolized particles. In particular, viruses, bacteria, other bio-aerosols, and volatile organic compounds are known to undergo aerosolization, wherein they rapidly evaporate in the air to form droplet nuclei that are small and light enough to remain suspended in the air. More specifically, these aerosolized particles can have an aerodynamic diameter less than or equal to 5 making them difficult to detect without specialized equipment and allowing them to spread easily. As such, these aerosolized particles can pose a high risk to respiratory health (e.g., a risk of respiratory damage or infection) no matter how far away an individual may be from the source of the contaminant since the particles can remain suspended in the air for long periods. For example, some bio-aerosols are known to stay suspended in the air for minutes, while others can stay suspended for hours, allowing them to travel great distances. Furthermore, the risk of transmission to others can be exacerbated in indoor areas where people gather in numbers and in areas with poor ventilation.

Currently, personal protective equipment (PPE) can be used to help protect an individual from aerosolized contaminants. For example, cloth or medical masks (e.g. N95 masks/respirators) may be used to provide short-term protection to an individual. However, these types of PPE must be properly fitted to (i.e. sealed against) the user's face in order to be effective, a task which is not always easy to accomplish for a general population that is not familiar with the proper usage of medical masks or that is using ill-fitting cloth masks. Furthermore, sealing the masks tightly to the skin surface is not ideal as many users may experience thermal discomfort and/or breathing difficulties, leading to some users intentionally wearing such masks improperly. Likewise, some individuals may have medical conditions that prevent them from wearing masks at all. These individuals may instead choose to wear face shields. However, similar to masks, the gaps that exist between the wearer's face and the shield can allow aerosolized particles to enter the wearer's respiratory system, rendering the shields ineffective. Moreover, masks represent simple passive filters that do not increase or decrease their protection/filtration in response to environmental conditions, but rather are simply passive filters.

In light of the above, a need exists for an improved form of wearable PPE that can provide a user with a dedicated clean air supply (i.e., a personalized airflow) to protect against both aerosolized and non-aerosolized contaminants. Furthermore, it is desirable that the improved PPE be lightweight and portable, produce less secondary environmental pollutants (such as synthetic textile by-products), and be able to run for prolonged periods of time, be able to reduce buildup of moisture and CO₂ in front of the user's mouth/nose, and be able to mitigate user discomfort and any potential difficulties in breathing. The discussion above is merely provided for general background information and is not intended to unduly limit the scope of the claimed subject matter.

### SUMMARY

One or more of the above problems can be solved by providing various systems and methods, such as a wearable air cleaner, that can remove particulate, aerosolized and other contaminants from air and direct the cleaned air as a personalized ventilation to a wearer. The features and advantages of such systems and methods can be implemented via various configurations, processes, devices, and other embodiments having alternative components and functionality.

For example, in one respect, a personal airflow device may be provided, which comprises: an airflow inlet; a first filter through which airflow from the airflow inlet passes; an airflow outlet connected to receive the airflow from the first filter, and disposed within the airflow device such that, when the airflow device is worn on a user's head, the airflow outlet is proximate to the user's nose; a first sensor configured to measure an attribute relating to the airflow; a processor; a memory in communication with the processor having instructions stored thereon which, when executed, cause the processor to: receive a first signal from the first sensor indicative of an attribute relating to the airflow; and in response to the first signal, send a second signal to a fan regulating the airflow through the airflow inlet, so as to adjust an envelope of filtered airflow created by the airflow outlet proximate to the user's nose, wherein the airflow device comprising the airflow inlet, first filter, airflow outlet, first sensor, processor, and memory is configured to be worn about the head of a user.

In some embodiments, the personal airflow device may further include a fan connected to provide the airflow to the airflow inlet. The fan may be external to the airflow device, and can include a conduit connecting the fan to the airflow inlet of the airflow device. The fan can be worn by a user separately from the airflow device.

In some embodiments, the first sensor may be a pressure sensor positioned to measure a pressure differential relative to the first filter.

In some embodiments the instructions may further cause the processor to receive a signal from a second sensor. The signal from the second sensor may be indicative of an attribute of ambient air near the user. The second sensor may be a contaminant sensor.

In some embodiments, the personal airflow device may further include a wireless transceiver, and the second sensor may be disposed external to the airflow device, and the signal from the second sensor is indicative of contaminant content of ambient air near the user. Additionally, the personal airflow device may further include a disinfection module disposed within the airflow device to receive filtered airflow from the first filter. The instructions may further cause the processor to receive a second signal from the second sensor indicative of contaminant content of the airflow and, in response to the second signal from the second sensor, adjust a setting of the disinfection module.

In some embodiments, the airflow outlet may be configured to be seated over a user's nose bridge and distribute the envelope of filtered air downward over the user's nostrils and mouth.

In some embodiments, the instructions may further cause the processor to determine, based on the first signal from the first sensor, a relative particulate content level of ambient air near the user and send the second signal to the fan to increase a flow rate of the envelope of filtered air and thereby dynamically increase the user's inhalation of filtered air as a percentage of total air inhalation relative to the particulate content level.

In some embodiments, the personal airflow device may further include an ambient airflow sensor disposed on an outer surface of the airflow device. The ambient airflow sensor may be connected to send a third signal to the processor, the third signal from the ambient airflow sensor being indicative of ambient airflow rate near the user's head. The instructions may further cause the processor to determine, based on the third signal from the ambient airflow sensor, a relative ambient airflow rate near the user and send a third signal to the fan to increase a flow rate of the envelope of filtered air and thereby dynamically increase the user's inhalation of filtered air as a percentage of total air inhalation.

In some embodiments, the airflow outlet may include a pair of nozzles configured to shape and orient filtered airflow as an airshield over the user's nose and mouth. The second signal sent by the processor to the fan can cause the fan to generate an airflow exiting the airflow outlet sufficient to displace contaminated air away from the user's breathing orifices such that the user inhales at least 50% filtered air.

In another respect, a method for providing personalized airflow may be provided, comprising the steps of: detecting a change in a characteristic of particle content of ambient air near a user; in response to detecting the change, initiating an airflow passing through a filter of a device worn by a user yielding filtered airflow; directing the filtered airflow out of an airflow outlet situated proximate a user's nose, so as to generate a shaped airshield over the user's nose and mouth; and adjusting a rate of the filtered airflow such that the user inhales at least 50% filtered air.

In some embodiments the rate of the filtered airflow may approximately 0.38 L/s. Additionally, the characteristic of particle content of ambient air may include at least one of: large particulate matter content and presence of bioaerosols.

In some embodiments, the method of providing personalized airflow may further include the step of, in response to a change in presence of bioaerosols, initiating a disinfection module to disinfect the filtered airflow.

In yet another aspect, a wearable device may comprise a housing configured to be worn on a user's head; an airflow inlet disposed at an exterior surface of the housing; a fan creating a positive airflow to the airflow inlet; a first filter positioned within the housing to receive airflow from the airflow inlet and allow the airflow to pass through the first filter; a first pressure sensor positioned within the housing to measure a differential pressure across the first filter; a contaminant sensor configured to detect bioaerosols within the filtered airflow from the first filter; a disinfection module disposed within the housing to receive filtered airflow from the first filter; an airflow outlet disposed at an exterior surface of the housing, comprising at least one nozzle configured to distribute an airflow shield over a user's nose and mouth when the housing is worn by the user; an ambient conditions sensor configured to detect at least one condition of ambient airflow near the user's head when the housing is worn by the user; and a processor coupled to a memory having software instructions stored thereon which cause the processor to: increase fan speed in response to detecting a pressure drop over the first filter; alert a user to replace the first filter when a persistent pressure drop over the first filter exceeds a threshold; initiate the disinfection module in response to detection of bioaerosols by the contaminant sensor; and adjust fan speed relative to ambient airflow near the user's head, to maintain a desired level of user inhalation of filtered air from the airflow outlet.

This Summary and the Abstract are provided to introduce a selection of concepts in a simplified form that are further described below in the Detailed Description. This Summary is not intended to identify key features or essential features of the claimed subject matter.

### DRAWINGS

The following detailed description is to be read with reference to the figures, in which like elements in different figures have like reference numerals. The figures, which are not necessarily to scale, depict selected embodiments and are not intended to limit the scope of embodiments of the disclosure. Given the benefit of this disclosure, skilled artisans will recognize that the examples provided herein have many useful alternatives that fall within the scope of the disclosure.

FIG. 1 is a schematic view of an example air cleaning device according to aspects of the disclosure;

FIG. 2 is a front plan view of another example air cleaning device according to aspects of the disclosure, the example air cleaning device configured as eyewear;

FIG. 3 is a right-side plan view of the example air cleaning device of FIG. 2;

FIG. 4 is a front detail view of the example air cleaning device of FIG. 2 taken about line 2-2;

FIG. 5 is a front detail view of the example air cleaning device of FIG. 2 taken about line 4-4;

FIG. 6 is a perspective view of another example air cleaning device according to aspects of the disclosure configured as a hip-supported device having a hip attachment portion and a headband portion;

FIG. 7 is a front perspective view of the hip attachment portion of the example air cleaning device of FIG. 6;

FIG. 8 is a back perspective view of the hip attachment portion of the example air cleaning device of FIG. 6;

FIG. 9 is a front plan view of the headband portion of the example air cleaning device of FIG. 6;

FIG. 10 is a detailed view of an orifice of the headband the example air cleaning device of FIG. 6;

FIG. 11 is a perspective view of the example air cleaning device of FIG. 6 including a shield; and

FIG. 12 is a perspective view of the example air cleaning device of FIG. 6 including a mask.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having,” and variations thereof, herein is meant to encompass the items listed thereafter and equivalents thereof as well as additional items. Unless specified or limited otherwise, the terms “mounted,” “connected,” “supported,” and “coupled,” and variations thereof, are used broadly and encompass both direct and indirect mountings, connections, supports, and couplings. Likewise, “connected” and “coupled” are not restricted to physical or mechanical connections or couplings unless identified as such. Furthermore, throughout the description, terms such as front, back, side, top, bottom, up, down, upper, lower, inner, outer, above, below, and the like are used to describe the relative arrangement and/or operation of various components of the example embodiment; none of these relative terms are to be construed as limiting the construction or alternative arrangements that are within the scope of the claims.

The following discussion is presented to enable a person skilled in the art to make and use embodiments of the disclosure. Given the benefit of this disclosure, various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize that the examples provided herein have many useful alternatives and fall within the scope of embodiments of the disclosure.

As noted above, a need exists for an improved form of wearable PPE device that is both lightweight and portable (e.g., that can be worn by a user and does not require any external devices to operate), which can provide a dedicated clean air supply (e.g., a personalized airflow) to a user under a variety of conditions and for long durations of time. For example, in some cases, such a device may need to provide a clean air supply where a user is sedentary, while in other cases, a user may be moving or the air in the surrounding environment may be moving (e.g., due to wind or an HVAC system), which can interrupt the clean air supply provided by the device. Similarly, depending on the specific application, such a device may need to be particularly adapted to filtering out larger particulate matter, while in other applications, the device may need to be adapted to filtering out smaller particulate matter and/or disinfecting aerosolized contaminants (e.g. viruses, bio-aerosols, and/or VOCs). However, it is appreciated that devices, systems, and methods as described herein may also be useful in other applications where compactness, portability, ease of transport and assembly, efficiency, and long-term durability are desirable.

One example for addressing these shortcomings of existing systems, and meeting the needs described above, is to provide personalized ventilation (PV), that is, a personalized airflow of clean air to an individual. A PV system may be adapted to confront many external factors, for example, complex interactions with breathing flow, convective flow around the human body, and room/environmental ventilation flow or wind. To properly ventilate the breathing zone and protect respiratory health, personalized airflow can include a sufficiently high momentum (speed) to penetrate the convective flow around the face, as well as a sufficiently large flow rate to compensate for its dispersion into an environment/room by mixing with the surrounding air. Additionally, it would be desirable in some circumstances to promote mobility and avoid large fans/blowers that rely on an external power source to operate, limiting their implementation to larger, non-portable structures such as hospital beds, seat headrests, and standalone air supplies that deliver air to a headset via a hose.

As described in greater detail below, a wearable PPE device having the various features and advantages described herein can provide a user with a dedicated clean air supply that can reduce the risk of respiratory damage and/or infection. More specifically, such a device can create a flow of clean (i.e., filtered and/or disinfected) that is directed to pass in front of the user's nose and mouth. This personalized airflow acts as both a personal air supply to the user and as an air barrier that can reduce or prevent contaminated air from the environment from being inhaled by the user. Additionally, the personalized airflow may provide a secondary cooling effect by aiding in heat dispersion.

To provide adequate protection of respiratory health, the personalized airflow needs a sufficiently high volumetric flow rate to overcome the convective effects of environmental air around or otherwise near the user's face. Additionally, the volumetric flow rate and shape of the flow must be such that the personalized airflow can compensate for the natural dispersion and mixing of the clean air into the surrounding environment. Such natural mixing may be increased by, for example, a) respiratory flow of the user, b) convective flow around the user (e.g. ascending thermal plume), c) room/environmental ventilation flow. Furthermore, to reduce the effect of mixing personalized and environmental air, it is preferable that the personalized airflow be provided in a sustained manner and to provide the clean airflow closer to the mouth and nose of the user.

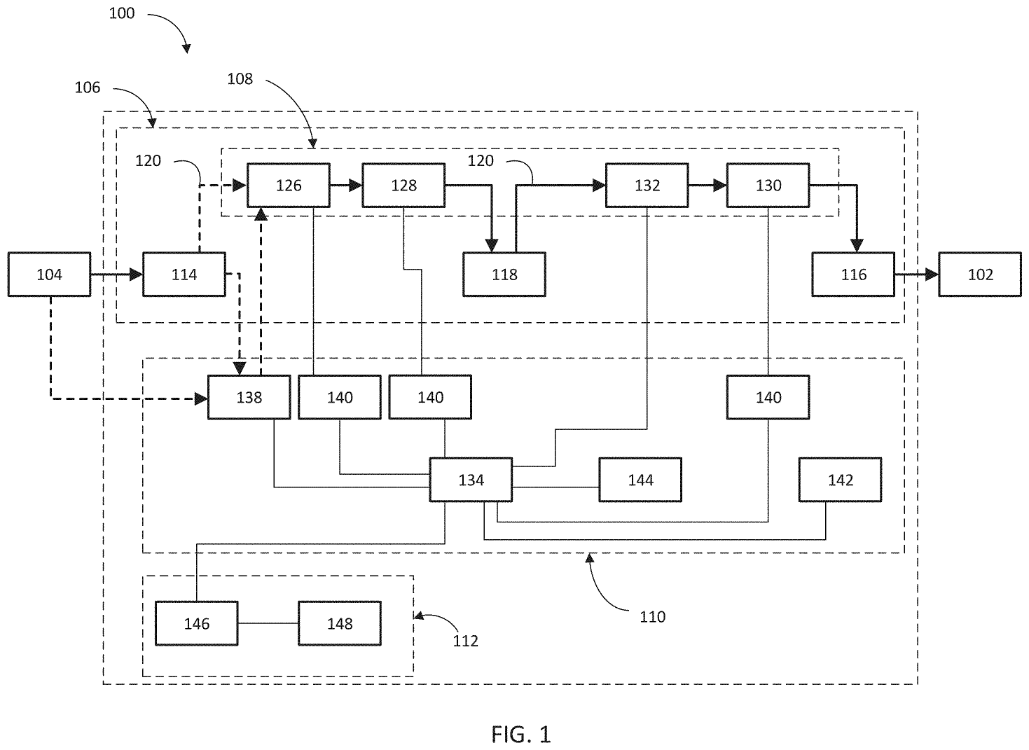

FIG. 1 illustrates a schematic of a wearable air cleaning device 100 for providing a personalized airflow 102 to a user. The air cleaning device 100 provides said personalized airflow 102 by taking in contaminated air 104 from the surrounding environment, cleaning the contaminated air 104 by removing and/or disinfecting particulate (e.g., aerosolized) matter in the contaminated air 104, and providing the cleaned (e.g., purified) air to the user near their mouth and nose as the personalized airflow 102. The air cleaning device 100 generally includes an air delivery system 106, a contaminant removal system 108, a control system 110, and a power management system 112, but may also include other systems or subsystems. As discussed below, these systems may be integrated with one another (e.g., various components of the contaminant removal system 108 and the control system 110 may be dispersed along and connected with the air delivery system 106) to allow the air cleaning device 100 to deliver the personalized airflow 102 to the user. Put another way, the systems may also be considered subsystems, for example, the contaminant removal system 108 may be a subsystem of the air delivery system 106. Additionally, the air cleaning device 100 may be contained in a single housing, or alternatively, various systems, subsystems, or individual components thereof may alternatively be provided in multiple housings or no housing at all.

The air delivery system 106 takes in contaminated air 104 from the surrounding environment and forces (e.g., moves) the contaminated air 104 through the air cleaning device 100 so that it can be delivered as the clean, personalized airflow 102 to the user. The air delivery system 106 includes an air inlet 114, an air outlet 116, and a fan 118. Additionally, the air delivery system 106 includes air conduit 120 for transporting air through the air cleaning device 100, which can be flexible or rigid tubing, or channels formed in a housing. The air conduit 120 is configured to connect the fan 118 with the air inlet 114 on one side and the air outlet 116 on the other to allow air to flow through the air cleaning device 100. However, in some cases, the air inlet 114 may be integrated with the fan 118 so that there is no air conduit 120 between the fan 118 and the air inlet 114. Additionally, as will be described in greater detail below, the air conduit 120 may or may not connect with portions of each of the contaminant removal system 108 and the control system 110.

The air inlet 114 is an opening (e.g. orifice) of the air cleaning device 100 that allows contaminated air 104 from the environment to enter the air cleaning device 100. More specifically, the fan 118 creates a pressure drop at the air inlet 114 that causes the contaminated air 104 to be pulled into the air cleaning device 100 through the air inlet 114. In some cases, the air inlet 114 may be covered by a grille, screen, and/or filter media (not shown) that acts as a pre-filter to prevent large debris, which could damage or clog the air cleaning device 100, from entering into the air delivery system 106. Furthermore, the air inlet 114 may include more than one air inlet 114.

The air outlet 116 is an opening of the air cleaning device 100 that allows the personalized airflow 102 to be provided to the user. To do so, the air outlet 116 is generally provided near the nose and/or the mouth of the user and is configured to direct and shape the personalized airflow 102 around the mouth and nose of the user. For example, the air outlet 116 may include a distribution grille and/or nozzles (not shown) that are configured to shape and orient the personalized airflow 102 in a particular direction, preferably over the user's nose and mouth. This distributed, personalized airflow 102 protects the user from inhaling infectious or hazardous aerosols or other particulate matter or contaminants from the environment by creating an air shield (i.e., a blanket of moving air) around the user's nose and mouth. More specifically, the personalized airflow 102 from the air outlet 116 of the air cleaning device 100 displaces the contaminated air 104 away from the user's breathing orifices.

The flow rate (e.g., volumetric flow rate) of the personalized airflow 102 is provided by the fan 118, which can be an axial, centrifugal, crossflow, or any other type of fan. That is, the fan 118 is configured to drive an airflow through the air cleaning device 100 from the air inlet 114 to the air outlet 116. Preferably, the fan 118 is a low-power fan that can produce sufficient airflow (e.g., 0.35 L/s-1 L/s) to protect the user under a variety of conditions by displacing the surrounding contaminated air 104. That is, for example, the fan 118 can provide a low-flow rate when a user is not moving or if the surrounding contaminated air 104 is non-moving and can provide a high flow rate when a user is moving or when the contaminated air 104 is moving (e.g., due to wind or an HVAC system). Additionally, the fan 118 has a size and weight that allows the fan 118 to be carried by the user and will not impede the movement of the user. For example, the fan 118 may be integrated into a pair of eyewear or it may be configured to be carried on a belt or in a backpack.

With continued reference to FIG. 1, the air cleaning device 100 is configured to remove contaminants (e.g., pollutants) from the contaminated air 104 that is taken in through the air inlet 114 by the fan 118. In particular, the air cleaning device 100 may be adapted to remove air pollutants including but not limited to ozone, Volatile Organic Compounds (VOCs) and airborne particles including viruses, and/or inactivate the infectious viruses attached on the surface of the airborne particles. To do so, the air cleaning device 100 may include any number of filters and/or disinfection equipment (e.g., UV disinfection/irradiation) to remove and/or sterilize contaminants prior to expelling the air out of the air outlet 116 as a personalized airflow 102. The filters and disinfection equipment maybe connected with the air delivery system 106 and may be placed anywhere between the air inlet 114 and the air outlet 116. In this way, the air cleaning system may be considered a subsystem of the air delivery system.

For example, as shown in FIG. 1, the air cleaning device 100 may have a plurality of air filters including any of a coarse filter 126, a fine filter 128, and a charcoal filter 130, and a disinfection module 132, each of which may be individually detachable and replaceable. The coarse filter 126 is used to remove large particulate matter (e.g., dust). The fine filter 128 is used to remove finer particulate matter and can be made of non-woven fabric used in surgical masks, HEPA filter used in N95 masks, antimicrobial HEPA filter specified for infectious viruses, and/or other filters that can effectively remove the fine particulate matter. The charcoal filter 130 can be used to remove VOCs and ozone. It is appreciated that these filters can result in a pressure drop within the air cleaning device 100, and therefore not all filters may be used where high flow rates of personalized airflow 102 are desired. In some examples, one or more types of filters may be used, one or more types of filters may not be used, or no filter may be used.

The disinfection module 132 can be a UV disinfection module configured as an independent UV chamber, an air tube integrated with UV-LED (UV-tube), or both UV chamber and air tube with UV. In general, the disinfection module 132 includes a UV light (e.g., an LED) having a wavelength of 222-nm or 254-nm, but the former is preferable as it is considered not harmful to the eyes. Relatedly, it is preferable that the disinfection module 132 be made of material that cannot be penetrated by UV light. The disinfection module 132 may be positioned after any of the coarse filter 126, the fine filter 128, and the fan 118, and is preferably placed before the charcoal filter 130.

As mentioned above, each of the coarse filter 126, the fine filter 128, the charcoal filter 130, and the disinfection module 132 may be disposed anywhere along the air delivery system 106 so that they are between the air inlet 114 and the air outlet 116. However, in a preferred embodiment, the air cleaning device 100 is arranged so that the contaminated air 104 from the surrounding environment passes from the air inlet 114 and through the coarse filter 126 and then the fine filter 128 to the fan 118. In this way, large particulate matter can be removed so that it does not foul the fine filter 128. Additionally, any fine particulate matter can be removed by the fine filter 128 prior to reaching the fan 118, which can help to increase the long-term performance of the fan 118. However, it is also contemplated that the coarse filter 126 and the fine filter 128 can be placed in front of or behind the fan 118, depending on the allowable resistance to airflow and convenience for replacement. Furthermore, because the filters inherently cause a pressure drop and increase the resistance to airflow, it is appreciated that only one of the coarse filter 126 or the fine filter 128 may be used to allow the air cleaning device 100 to provide higher flow rates of the personalized airflow 102.

After passing through the fan 118, the air is then forced through the disinfection module 132 where any remaining viral or other biological contaminants can be neutralized by the UV light. Furthermore, after passing through the disinfection module 132, the air passes through the charcoal filter 130 to remove any ozone created by the UV radiation, and/or any remaining VOCs. Once through the charcoal filter 130, the air can be ejected through the air outlet 116 as the personalized airflow 102.

With continued reference to FIG. 1, the control system 110 is configured to ensure that the air cleaning device 100 is capable of removing contaminants from the contaminated air 104 in an amount sufficient to provide the personalized airflow 102 to the user. For example, the sir cleaning device 100 may be configured to meet a variety of OSHA, EPA, and/or ASHRAE requirements for air quality. It is appreciated that the specific standard to be met may depend on the specific application.

The control system 110 includes a microcontroller 134 that may have or may be connected to a memory on which is stored a program comprising a set of software instructions, which may include models of the air delivery system 106, air cleaning device 100, and power management system 112. In some embodiments, the program may be configured to instruct the microcontroller 134 to monitor device performance and modify operating parameters (e.g. changing the speed of the fan 118 and turning the disinfection module 132 on and off), to ensure a sustained personalized airflow 102, while also minimizing power consumption. In further embodiments, the microcontroller 134 may be programmed to monitor environmental conditions and/or user feedback to dynamically adapt control signals to various components to cause the device to perform according to its detected surroundings. The microcontroller 134 may be operatively (e.g., electrically) connected with each of the fan 118 and the disinfection module 132 so that the microcontroller 134 can operate the fan 118 and the disinfection module 132.

Additionally, the control system 110 may include a plurality of sensors that provide input to the microcontroller 134. The sensors may include a contaminant sensor 138, a number of filter sensors 140 corresponding with each of the filters, and an accelerometer 142. However, other sensors, for example, a graphene-based biosensor, a temperature sensor, an NDIR CO₂ concentration sensor, an optical particle counter, particle size analyzers, an electric current sensor, and/or a humidity sensor, may also be included. Similarly, in additional embodiments, the sensors may also include sensors that gather active or passive feedback from the user. For example, an accelerometer may provide information as to the movement of the user and a microphone may provide information on how frequently a user is coughing or sneezing, as a measure of the degree of contaminants in the ambient air.

The contaminant sensor 138 is configured to analyze the contaminated air 104 of the environment and provide a corresponding signal to the microcontroller 134. More specifically, the contaminant sensor 138 may provide one or more signals to the microcontroller 134 to indicate, for example, the concentration and/or types of contaminants in the contaminated air 104. In particular, the contaminant sensor 138 may be able to sense a number of physical, chemical and biological air pollutants (e.g., temperature, humidity, PM1.0, PM2.5, PM10, O3, formaldehyde, CO2, bio-aerosols, particulate matter, and/or VOCs). It is appreciated that the contaminant sensor 138 may be an optical sensor, an electro-chemical sensor, or any other type of sensor.

In response, the microcontroller 134 can control the speed of the fan 118 and/or the disinfection module 132 based on the embedded program to remove the contaminants from the contaminated air 104. For example, the contaminant sensor 138 may sense that the contaminated air 104 only includes particulate matter and may turn off the disinfection module 132 to reduce power consumption. Similarly, if bio-aerosols are detected, the microcontroller may increase the UV output of the disinfection module 132. Moreover, the microcontroller 134 may send a signal to an indicator module 144 (e.g. an LED indicator module or an LED display) so that real-time air quality can be displayed to the user by the indicator module 144. In some cases, the contaminant sensor may alternatively or additionally pair with an app for use with an external device (e.g., a mobile phone or a computer) to monitor and control air quality and the operation of the air cleaning device 100 (e.g., fan speed and/or UV output). In yet further embodiments, an external contaminant sensor may provide wireless indications to the microcontroller 134 of ambient contaminants. For example, an optical sensor or series of optical sensors, disposed within a facility may detect contaminants in ambient air, and provide wireless signals (whether locally (e.g., via Bluetooth) or via WiFi) to a device to cause it to alter fan operation, disinfection operation, or other settings accordingly. In some embodiments, these sensors may provide targeted or localized signals so that only those devices within an expected zone of contaminant receive such signals (e.g., based on location and/or airflow patterns).

To measure the concentration and type of contaminants in the contaminated air 104, the contaminant sensor 138 samples the contaminated air 104 prior to such air entering any portion of the contaminant removal system 108. The sampling rate of the contaminant sensor 138 may be fixed or varied. As shown in FIG. 1, the contaminant sensor 138 may be disposed between the air inlet 114 and the coarse filter 126 so that it samples the contaminated air 104 that has passed through the air inlet 114. However, in other embodiments, the contaminant sensor 138 may include a separate inlet (not shown) so that it can directly sample the contaminated air 104 in the surrounding environment. Such a configuration may be desirable where the air inlet 114 is positioned away from a user's nose and mouth. In this way, the contaminant sensor 138 can sample the contaminated air 104 from a source that is closer to a user's mouth and nose to provide more accurate information about any contaminants that the user is likely to inhale.

The filter sensors 140 may be separate sensors or they may be integrated within a filter. The filter sensors 140 are configured to indicate and/or measure fouling of the respective filter (e.g. the coarse filter 126, the fine filter 128, and the charcoal filter 130). More specifically, the filter sensors 140 may be pressure sensors that measure a pressure drop over the respective filter (e.g., a differential pressure measured between the inlet side of the filter and the outlet side of the filter). As the air cleaning device 100 operates, particulate matter from the contaminated air 104 accumulates on the filters, which increases the resistance to the airflow through the filters (e.g., filters 126, 128, 130). The increased resistance to airflow can be ascertained by detecting an increased pressure drop over the filters. In this way, the filter sensors 140 can measure the change in pressure drop over time to detect the increased flow resistance, which can be correlated with the life expectancy of the filters. The filter sensors 140 signal the pressure drop to the microcontroller 134, which can adjust the speed of the fan 118 to account for the increased pressure drop that results from fouling. For example, as a filter becomes fouled microcontroller 134 can increase the speed of the fan 118 to overcome the increased resistance to airflow. Furthermore, once the pressure drop becomes high enough, the microcontroller 134 can signal (e.g., audibly, visually, haptically, etc.) to the user that the filter needs to be replaced. Moreover, the microcontroller 134 may also provide a signal to the indicator module 144 to provide filter status and replacement information to the user. In other embodiments, a filter sensor may not be included, in which case the microcontroller 134 may record the time of operation to estimate fouling and to adjust the fan speed accordingly.

The accelerometer 142 is configured to indicate movement of the user. As the user moves, the user creates a flow of contaminated air 104 around the user's nose and mouth. This movement of contaminated air 104 can cause the personalized airflow 102 to disperse away from the user's nose and mouth, leaving them susceptible to potential respiratory harm from breathing in the contaminated air 104. As such, the accelerometer 142 may provide a signal to the microcontroller 134 that the user is moving. In response, the microcontroller 134 can increase the speed of the fan 118 to provide an increased volumetric flow rate of the personalized airflow 102, which may overcome the increased dispersion and protect the user. Similarly, if the accelerometer 142 indicates that the user is no longer moving, the microcontroller 134 can reduce the speed of the fan 118 to reduce power consumption.

With continued reference to FIG. 1, the power management system 112 includes a battery 146 (e.g., a power supply) and an energy management module 148. The battery 146 can provide power to the microcontroller 134, which can be used as an intermediary to power the fan 118, the disinfection module 132, and the indicator module 144 as shown in FIG. 1, or the battery may be directly connected with any of the fan 118, the disinfection module 132, and the indicator module 144. The energy management module 148 may be configured to control the charging of the battery 146 from an external power source (e.g., a USB charger or a wall outlet). Additionally, the energy management module 148 is configured to determine a state of charge (SOC) of the battery. Because the SOC of the battery 146 cannot be directly measured, a Kalman filter can be used to estimate the SOC based on the dynamic model of the battery 146 with the measured voltage and current. The energy management module 148 may include a microcontroller or hardware processor, which may be configured to run an embedded or stored program.

The estimated SOC signal can be sent to the control system 110 for the optimal fan/pump speed calculation. For example, if there is sufficient energy stored in the battery 146, the microcontroller 134 can deliver more power to the fan 118 and/or disinfection module 132 to meet or exceed the required personalized airflow 102. Conversely, if there is not sufficient energy stored in the battery 146, the microcontroller 134 can optimize power consumption with personalized airflow 102 and signal to the user, via the indicator module 144, that the personalized airflow 102 may be insufficient and that the user may be at greater risk for respiratory harm.

For example, the device can alert a user with an audio signal of low batter and give user a following two options (a) replace the battery or (b) run the air through a bypass route that circumvents the filters and directs the air into the UV disinfection channel to target bioaerosols only. Additionally or alternatively, the microcontroller 134 can optimize air quality (Q) and with energy consumption (E). This optimization can be described by the equation: Min(α₁*E−α₂ Q), where α₁ is the weight of energy consumption and α₂ is the weight of air quality. If there is sufficient energy, α₂ is set to be larger, the microcontroller 134 can allow the air cleaning device 100 to expend more energy to improve the air quality in the personalized airflow 102. Conversely, if there isn't sufficient energy, α₁ can be set to a larger value, so that the air cleaning device 100 can reduce the energy consumption.

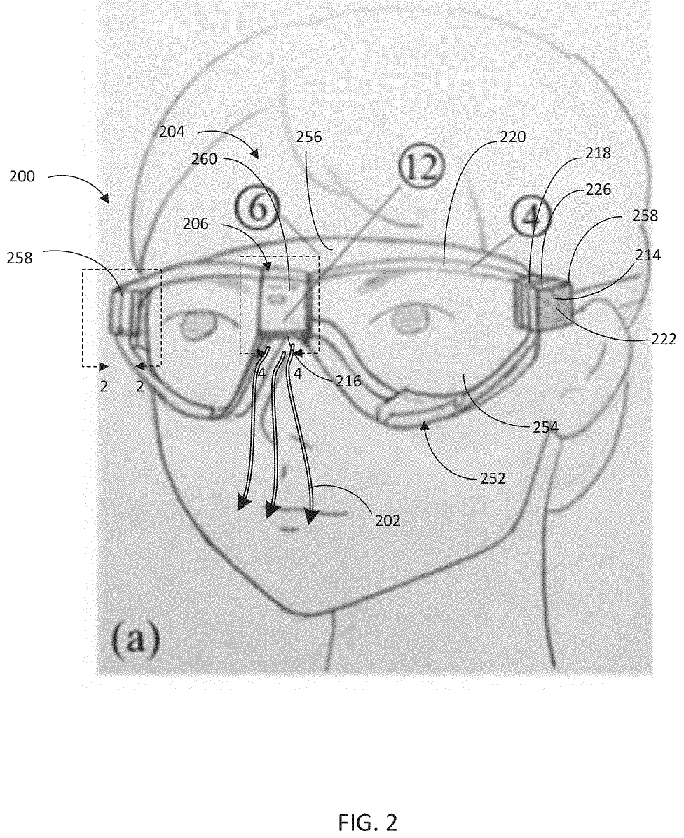

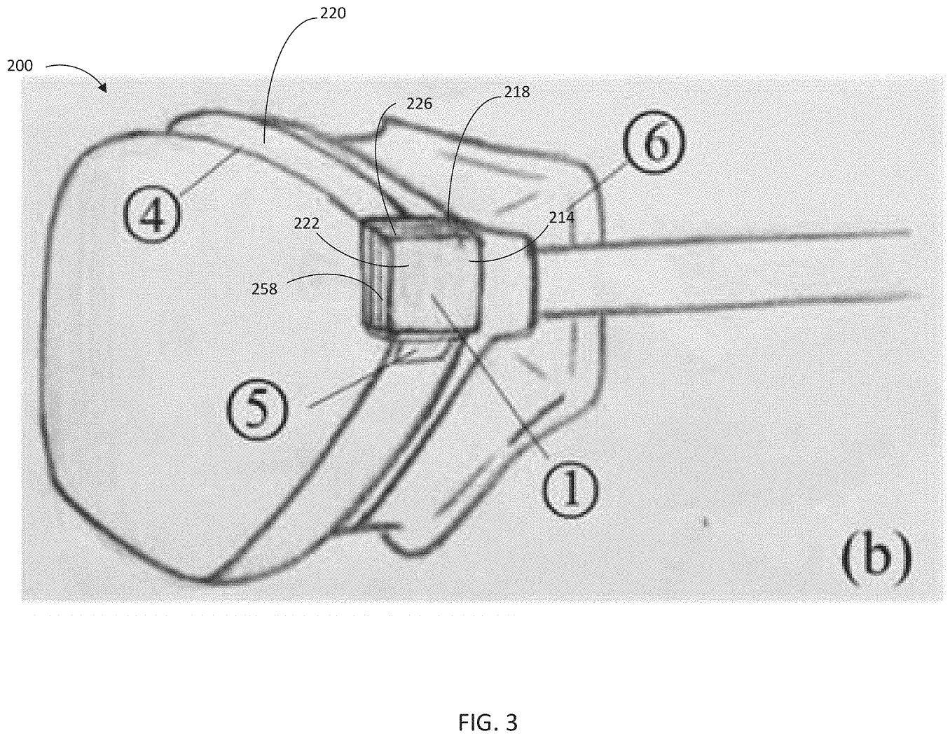

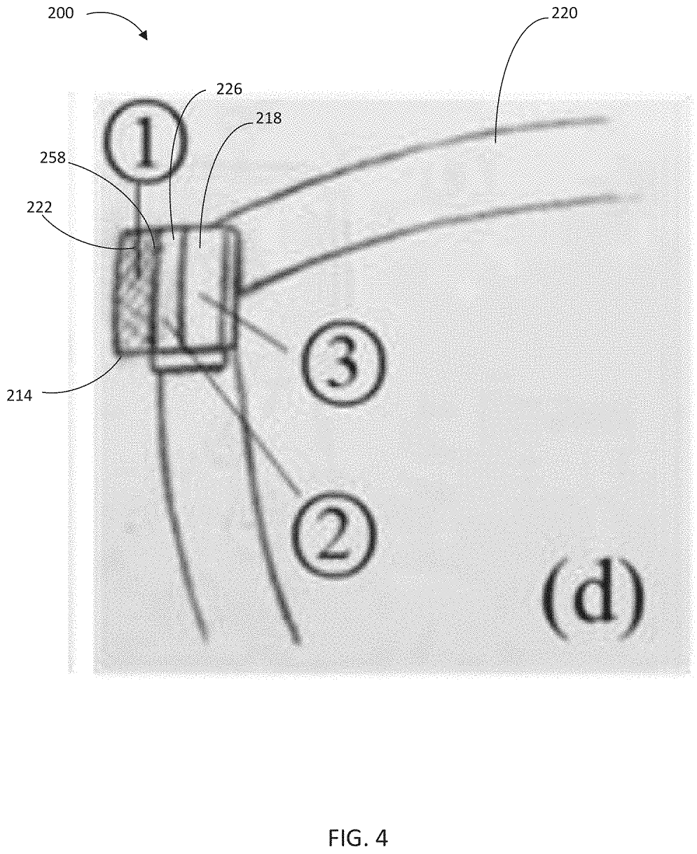

Turning now to FIGS. 2-5, an example air cleaning device 200 is shown configured as eyewear 252, and more specifically, a pair of goggles having a lens 254 to protect the eyes of the user and a sealing element 256 to seal around the eyes of the user. The air cleaning device 200 may be similar to the air cleaning device 100 and is shown being integrated into the eyewear 252 as end pieces 258 and a bridge piece 260 of the eyewear 252. Portions of an air delivery system 206 and a contaminant removal system 208 are disposed in each of the end pieces 258 and the bridge piece 260. A control system 210 and a power management system 212 are disposed within the bridge piece 260. As is discussed below the air cleaning device 200 is configured to clean the contaminated air 204 from the surrounding environment and to provide a personalized airflow 202 downward from the height of eyes of the user and along the nose and mouth of the user.

The end pieces 258 are detachable from the eyewear 252 but they may also be permanently attached. Each of the end pieces 258 includes an air inlet 214 having a mesh grille 222, a filter 226, a fan 218. The mesh grille 222 acts as a pre-filter to allow contaminated air 204 into the air inlet 214, while also preventing large objects from entering. The mesh grille 222 is removable to allow for sterilization and also for allowing easy replacement of the filter 226 and the fan 218. The filter 226 is a coarse filter that is configured to capture larger particulate matter, although other types of filters may also be used. In other embodiments, the filter 226 may include both a coarse filter and a fine filter (e.g., a HEPA filter). The fan 218 can be a micro fan (e.g., a 0.5 to 2.5 watt micro fan) that is positioned behind both the mesh grille 222 and the filter 226. The fan 218 and creates the necessary pressure drop to draw in contaminated air 204 from the environment through the air inlet 214. A damper (not shown) may be disposed around the fan 218 or between the end pieces 258 and the eyewear 252 to prevent vibrations caused by the fan 218 from passing through the eyewear 252 to the user. In other embodiments, the end pieces 258 may not include a fan, and one or more fans may be disposed within the bridge piece 260 instead.

After passing through the fan 218, the air passes through air conduit 220 that runs along the top of the eyewear to connect the end pieces 258 with the bridge piece 260. The air conduit 220 is sized to reduce the pressure drop inside the air conduit 220. The air conduit 220 may be made from a lightweight alloy, for example, beta titanium, memory metal, beryllium, etc. Additionally, and inner surface (not shown) of the air conduit 220 can have inner lining to smooth the surface and also to prevent unintentional folding to allow for sooth curving of the air supply tubing. It is appreciated that one or more wires (not shown) may run along the air conduit 220 to provide power to the fan 218 and to allow any sensors (e.g. a filter sensor) within the end pieces 258 to communicate with the control system 210. Once through the air conduit 220, the air flows into a disinfection module 132 that is disposed within the bridge piece 260. The disinfection module 232 may be a UV disinfection module having an LED that emits light having a wavelength within the UV spectrum, and preferably with a wavelength of 222-nm or 254-nm. Once disinfected, the air can be forced out of an air outlet 216 defined in the bottom of the bridge piece 260 to create a protective curtain of personalized airflow 202 around the user's nose and mouth. More specifically, the air outlet 216 can use a Coanda effect to keep the jet/curtain of personalized airflow 202 attached to the user's face so it comfortably delivers clean air to user's nose and mouth. It is preferable that the air outlet 216 be located at approximately the height of the eyes of the user and 5 mm away from the skin surface of the user to allow the personalized airflow 202 to fully cover the nose and mouth of the user. In this case, the air outlet 216 includes a diffusing grille 216A to help direct the personalized airflow 202, but this is not always required.

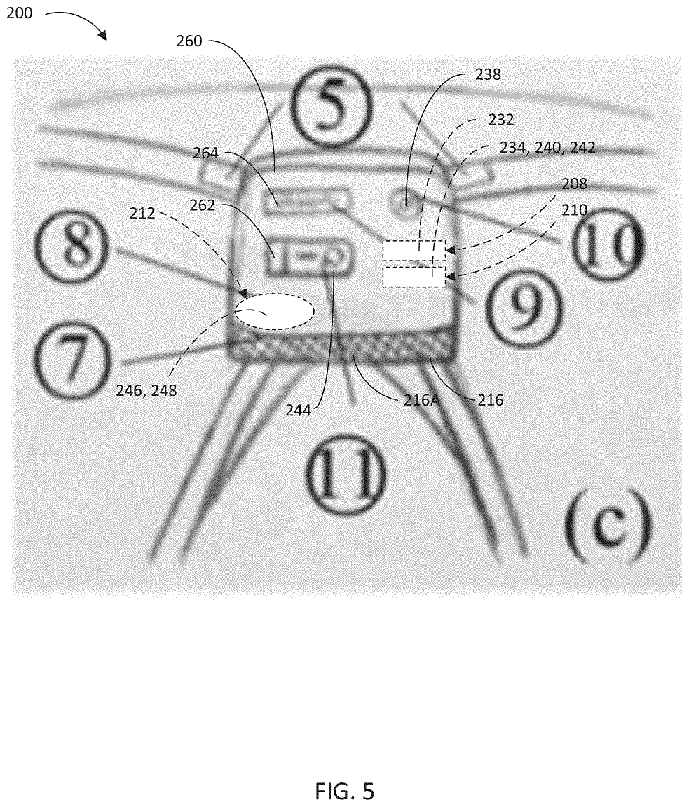

As is best shown in FIG. 5, the control system 210 is partially disposed within the bridge piece 260. More specifically, a microcontroller 234 is disposed entirely within the bridge piece 260 along with a filter sensor 240 and an accelerometer 242, and a contaminant sensor 238 extends through and opening in the bridge piece 260 to allow the contaminant sensor 238 to sample the contaminated air 204 near the user's nose and mouth. Furthermore, a switch 262 extends through the bridge piece 260 to allow the user to turn the air cleaning device 200 on and off, although the switch 262 may also be configured as a touch-sensitive (e.g., capacitive) switch that is disposed within the bridge piece 260. Furthermore, an indicator module 244 extends through the bridge piece, but may alternatively be disposed within the bridge piece 260. In the case that the indicator module 244 is disposed within the bridge piece 260, the indicator module 244 may be covered by a clear viewing window.

Additionally, as mentioned above, the power management system 212, includes a battery 246 (e.g., a power supply) and an energy management module 248 that are disposed within the bridge piece 260. The battery 246 may be, for example, a lithium-ion or other type of battery, and may be rechargeable or non-rechargeable. As shown, the battery 246 is a rechargeable battery 246 and a charging port 264 extends through the bridge piece 260 to allow the battery 246 to be recharged. In the case that the battery is non-rechargeable, the bridge piece 260 may include a removable piece (not shown), for example, a front or back cover to allow a user to replace the battery when needed.

A computational fluid dynamic simulation of the air cleaning device 100 was performed to assess device performance as compared with an Upper-Room Germicidal Ultraviolet (UR-GUV) system with four, 36-watt UV fixtures. The simulation included two humans, a host, and a recipient, facing one another and standing 0.93 m apart in a room having a width of 4.5 m, a length of 4 m, and a height of 3.5 m. A room inlet having a width of 0.5 m and a length of 0.5 was provided centrally at the top of the 4.5 m long wall and a room outlet having a width of 0.5 m and a length of 0.5 was provided centrally at the bottom of the opposing 4.5 m long wall.

The humans were centered in the room with the host (i.e., the infected human) having their back to the room inlet and the recipient having their back to the room outlet. Each of the host and the recipient had a heat flux of 23.1 W/m² and a nostril opening of 3.3 cm² that provided an exhaled flow rate of 0.5 L/s. The host was assumed to introduce a bio-aerosol into the room with aerodynamic diameters of ≤5 μm at a generation rate of 1.3 quanta/min. The recipient was wearing the air cleaning device 100 and the air outlet 116 was assumed to have a rectangular opening that was 2 cm long by 1 cm deep.

Five different cases were run, varying the number of air changes per hour (ACH) to be at 0.5 ACH, 1 ACH, 2 ACH, 3 ACH, and 6 ACH. In all five cases, approximately 71% (68.5% 72.8%) of personalized air was inhaled by the recipient. In particular, at 0.5 ACH, a volumetric flow rate of 0.38 L/s from the air cleaning device 100 led to a 77% reduction in the concentration of bio-aerosols at the nostril opening of the recipient, which is similar to the efficiency of the UR-GUV. By sensing particulates in the user's local environment and providing 0.38 L/s of filtered air to the wearer, simulations show that the device can reduce the bio-aerosols contaminants inhaled by up to 77%. Thus, providing clean air right above the breathing zone was able to significantly reduce the inhalation of viral bio-aerosols; importantly, this personalized air supply method could provide a stable source of clean air for inhalation almost irrelevant to indoor ventilation. Hence, it is an effective measure against aerosol transmission. Additionally, the concentration of bio-aerosols was significantly decreased throughout the entire room, thereby showing that the device can not only reduce exposure to infectious bio-aerosols for the user, but also for other occupants in a room with poor ventilation.

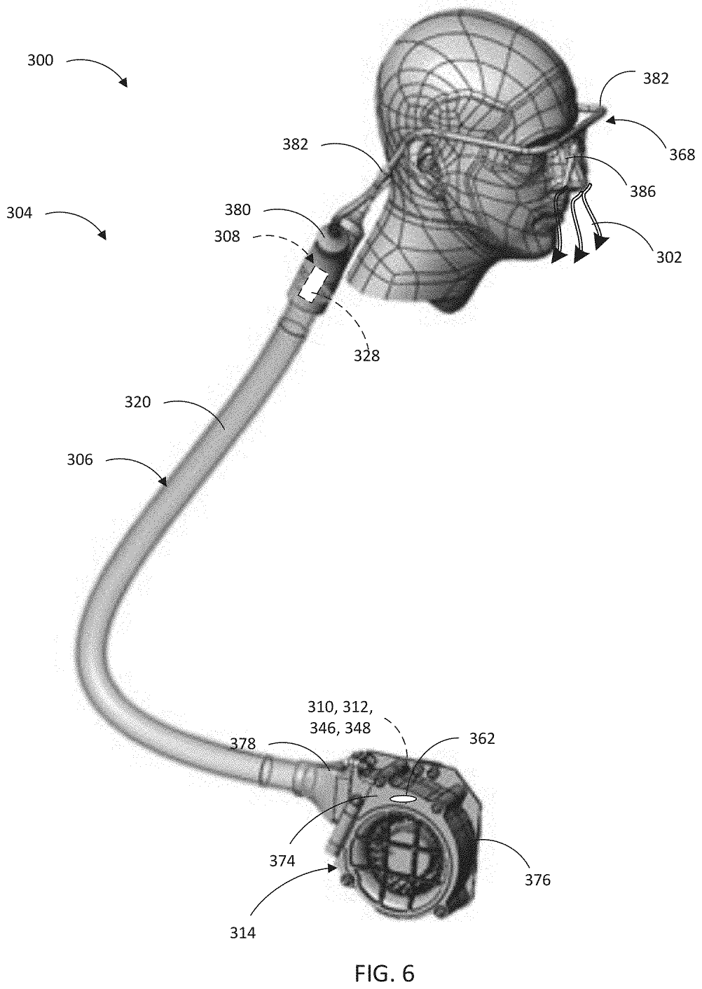

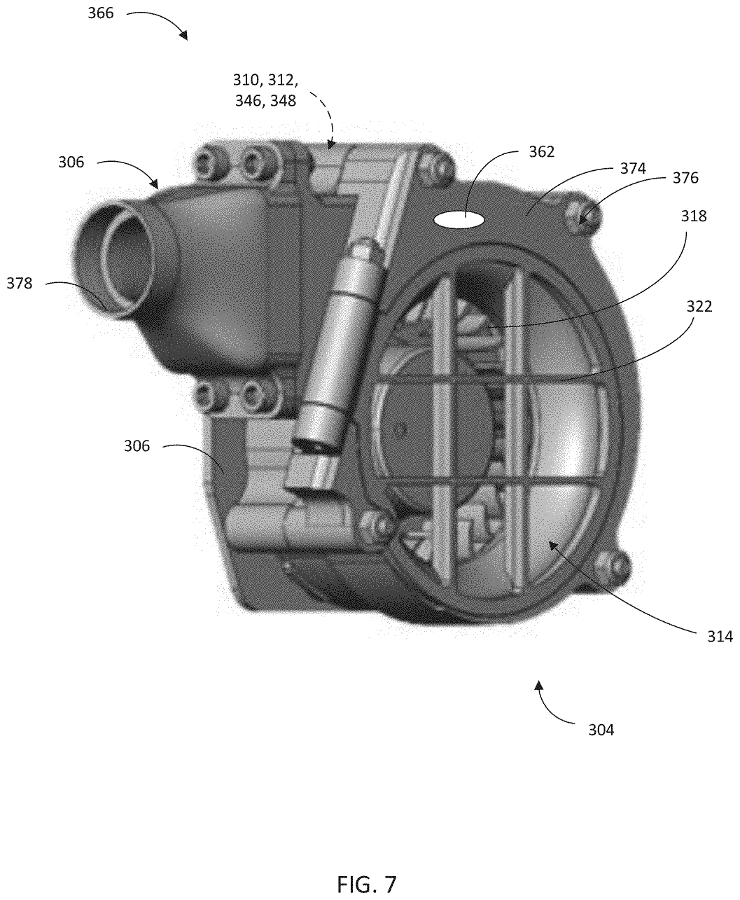

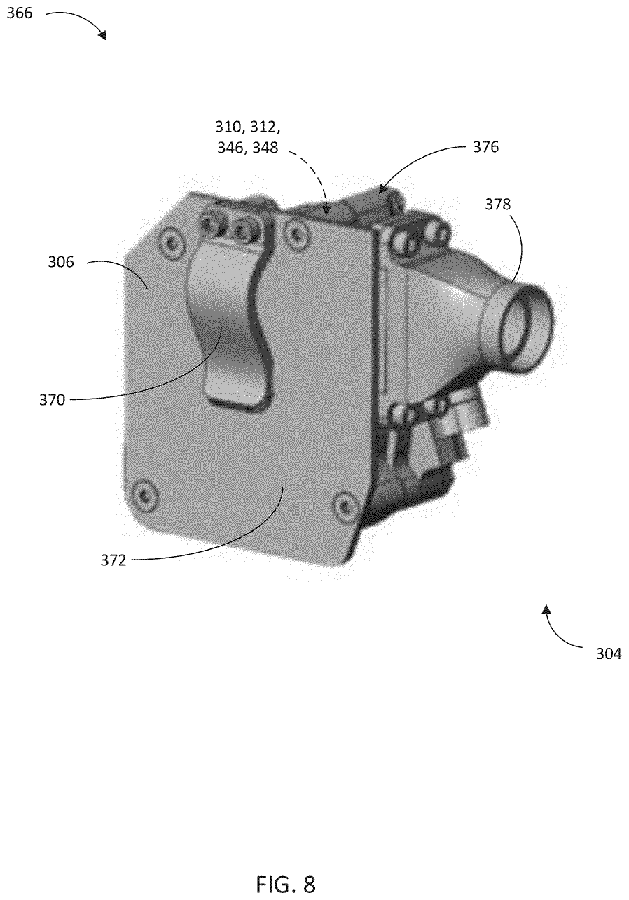

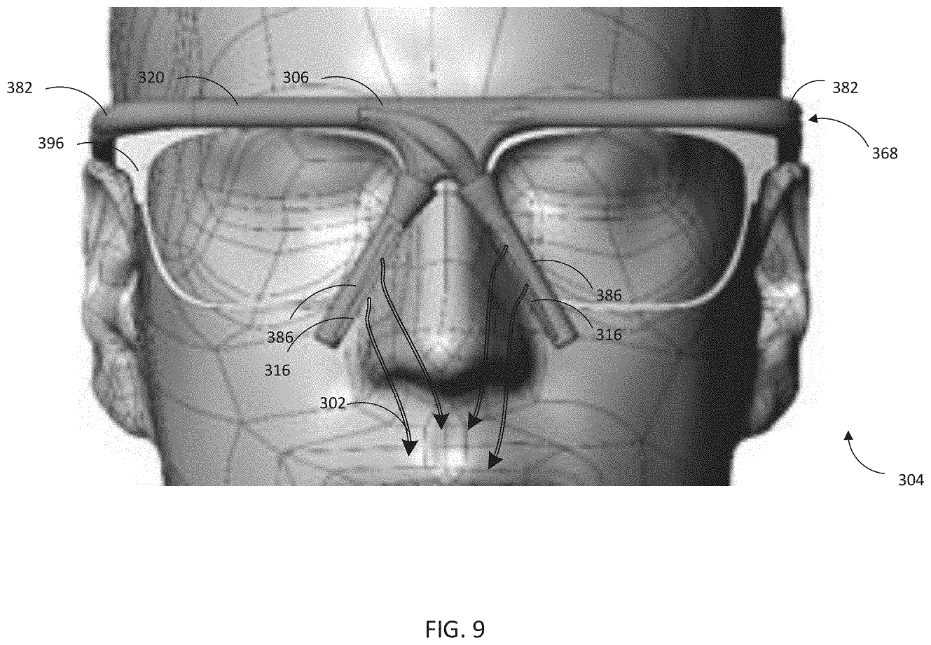

Turning now to FIG. 6-10, another embodiment of an air cleaning device 300 is illustrated according to aspects of the disclosure. The air cleaning device 300 is configured as a hip- or belt-supported device that includes a hip attachment portion 366 and a headband portion 368, which are connected by an air conduit 320. The hip attachment portion 366 includes a clip 370 (see FIG. 8) on a back side 372 that is configured to allow the hip attachment portion 366 to be hung on a belt or a waistband of a user. Similar to the previously described devices, the air cleaning device 300 includes an air delivery system 306, a contaminant removal system 308, a control system 310, and a power management system 312. As will be described in greater detail below, the air delivery system 306 is disposed between each of the hip attachment portion 366 and the headband portion 368. The contaminant removal system 308 is disposed within the air conduit 320 between the hip attachment portion 366 and the headband portion 368. The control system 310 and the power management system 312 are disposed in the hip attachment portion 366.

It is appreciated that such a configuration can allow for a larger fan and/or a larger battery to be used as compared to the air cleaning device 300. The larger fan and battery can allow for increased flow rates of personalized airflow, which may be needed in applications where there is high environmental airflow. Additionally, the increased battery size can allow for increased run times. Furthermore, by moving some of the weight of the air cleaning device 300 to the hip of a user, the air cleaning device 300 may offer increased comfort for the user when long-term usage is required.

With regard to the air delivery system 306, contaminated air 304 from the environment enters into the air cleaning device 300 via an air inlet 314 that is formed in a front side 374 of the hip attachment portion 366 that also serves as a housing 376 for a fan 318. As shown, the fan 318 is a centrifugal fan, but other types of fans may also be used. The hip attachment portion 366 includes a grille 322 that covers the air inlet 314 to protect the fan 318 from large debris. The grille 322 is rotatably attached to the front side 374 of the housing 376 of the hip attachment portion 366 and can be rotated away from the fan 318 (i.e. relative to the fan 318 and the housing 376) to allow for easy cleaning of the fan 318. In this case, contaminated air 304 can pass directly from the air inlet 314 and into the fan 318, however, in other embodiments, a filter may be positioned between the grille 322 and the fan 318.

After passing through the fan 318, the air exits the hip attachment portion 366 through an exit nozzle 378 and enters into the air conduit 320. The air travels along (i.e., through) the air conduit 320 toward the headband portion 368. Prior to entering the headband portion 368, the air passes through the contaminant removal system 308. As shown, the contaminant removal system 308 is a passive system that relies solely on a filter 328 to remove contaminants. More specifically, the filter 328 is disposed within a Y-shaped connector 380 that connects the air conduit 320 to the headband portion 368. As shown, the filter 128 is a fine filter, for example, a HEPA filter, but it may also be another type of filter. Because the filter 128 is contained in the connector, a larger-sized filter can be used. Additionally, more than one filter or type of filter may be used. It is appreciated that, in other embodiments, the contaminant removal system 308 may be an active system that alternatively or additionally includes a disinfection unit, for example, a UV disinfection unit. Furthermore, in other embodiments, the Y-shaped connector may instead be a linear connection that supplies clean air only along one side of the headband portion 368.

Once through the filter 328, the now clean air is split into two separate streams by the Y-shaped connector 380 to flow along each side of the headband portion 368. More specifically, each side of the headband portion 368 includes a tube 382 (i.e., an air conduit) that is configured to be supported by the ears of use. As shown, the tubes 382 are coupled to a frame 396 configured as a pair of glasses to provide additional support to the tubes 382 and enhance comfort for the user. However, the frame 396 is optional and the tubes may instead be supported directly by the ears of the user.

After passing along each side of the headband portion 368, the tubes 382 extend inward to cross the face of the user toward the nose. The tubes 382 preferably run above the eyes of the user so as not to impede the vision of the user. Upon reaching the nose of the user, the tubes 382 form nozzles 386 on each side of the nose of the user. More specifically, the tube 382 on the right side of the user's nose crosses over the nose so that the nozzle 386 extends downward (i.e., toward the mouth) along the left side of the nose of the user and the tube 382 on the left side of the user's nose crosses over the nose so that the nozzle 386 extends downward (i.e., toward the mouth) along the left side of the nose of the user. In this way, each of the tubes 382 independently feeds each nozzle 386. In other embodiments, the tubes 382 may instead join at the nose so that both of the tubes 382 feed both of the nozzles 386.

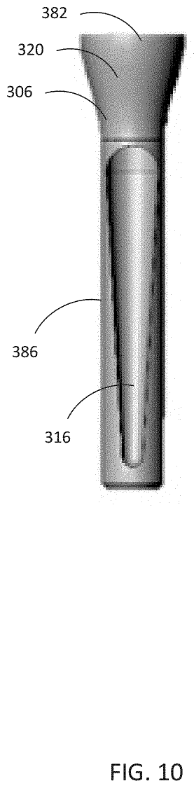

As is best seen in FIG. 10, each of the nozzles 386 includes an air outlet 316 (e.g., an orifice) that is configured to provide a curtain of personalized airflow 302 over the user's nose and mouth. As shown, the air outlets 316 have an inverted tear-drop-like shape that narrows along the length of the respective nozzle 386 as it extends away from the respective tube 382, but other shapes of orifices and/or numbers of orifices may also be used. The orifice shape can concentrate clean air to the breathing zone by providing a gradual change in the air outlet section to reduce the pressure drops of the air discharge. Additionally, while the air outlets 316 are depicted as being open orifices, they may alternatively be covered by a grill or other similar structure that may help to shape or otherwise control the personalized airflow 302.

With regard to the control system 310, the control system 310 includes a microcontroller disposed in the housing 376 of the hip attachment portion 366 and a switch 362 that protrudes from the housing 376 to allow the user to turn the air cleaning device 300 on and off. Additionally, the control system 310 optionally includes a fan speed control (not shown) that allows the user to manually adjust the fan speed. The fan speed control may be, for example, a dial that can be rotated by the user. As shown, the air cleaning device 300 does not include a containment sensor, a filter sensor, or an accelerometer, but this may not always be the case.

With regard to the power management system 312, the power management system 312 includes a battery 346 and an energy management module 348 disposed in the housing. The battery 346 may be, for example, a lithium-ion or other type of battery, and may be rechargeable or non-rechargeable. However, in other embodiments, in particular, where increased run times and/or increased flow rates of personalized airflow are desired, the power management system may instead be a separate component that can additionally be supported on a belt or waistband of a user and that can be electrically connected with the control system 310 hip attachment portion 366. Such a configuration may also allow a user to more quickly or easily replace a fully discharged battery and may also allow for batteries with larger capacities.

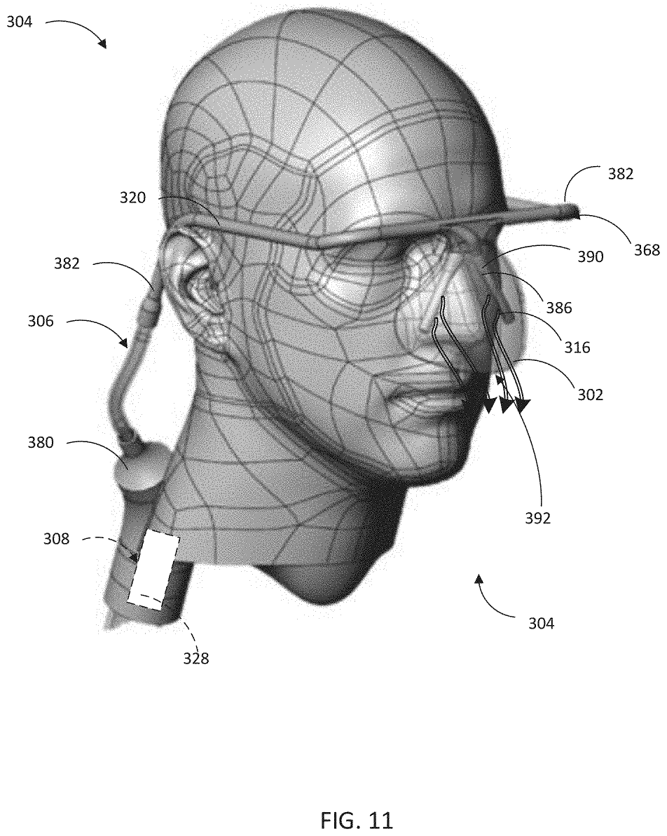

Turning now to FIG. 11, the air cleaning device 300 may further include a shield 390. The shield 390 may be a detachable or integral shield and is configured to help direct the personalized airflow 302 and to prevent the personalized airflow 302 from immediately mixing with the contaminated air 304 in the surrounding environment. In this way, the shield 390 can help increase the respiratory protection provided by the air cleaning device 300 in windy environments or where multiple users are in close proximity to one another. Additionally, by protecting the personalized airflow 302, the shield 390 can allow the air cleaning device 300 to maintain sufficient respiratory protection at lower flow rates of personalized airflow, resulting in the air cleaning device 300 being able to operate for longer periods of time.

As shown, the shield 390 is detachable and can attach to the device near the nozzles 386, for example, by a snap fit or an attachment bracket. The shield 390 is shaped and sized to surround the nose of the user so that a lower end 392 of the shield 390 is disposed between the nose and the mouth of the user. That is, the personalized airflow 302 flowing along the nose of the user is contained behind the shield 390 and then becomes exposed to the surrounding contaminated air 304 after flowing beyond the lower end 392 of the shield 390, near the mouth of the user. In other embodiments, the shield 390 may be shaped differently. For example, the shield 390 may be larger so that the shield 390 covers both the nose and the mouth of the user. In this way, a larger shield can provide greater protection to the user by ensuring the personalized airflow 302 covers both the nose and the mouth of the user, which may be desirable in long-term and/or high-exposure applications. The shield 390 may be made of a flexible material, for example, a polymer or a fabric. In particular, the shield 390 may be made of a clear material so as not to impede the vision of the user.

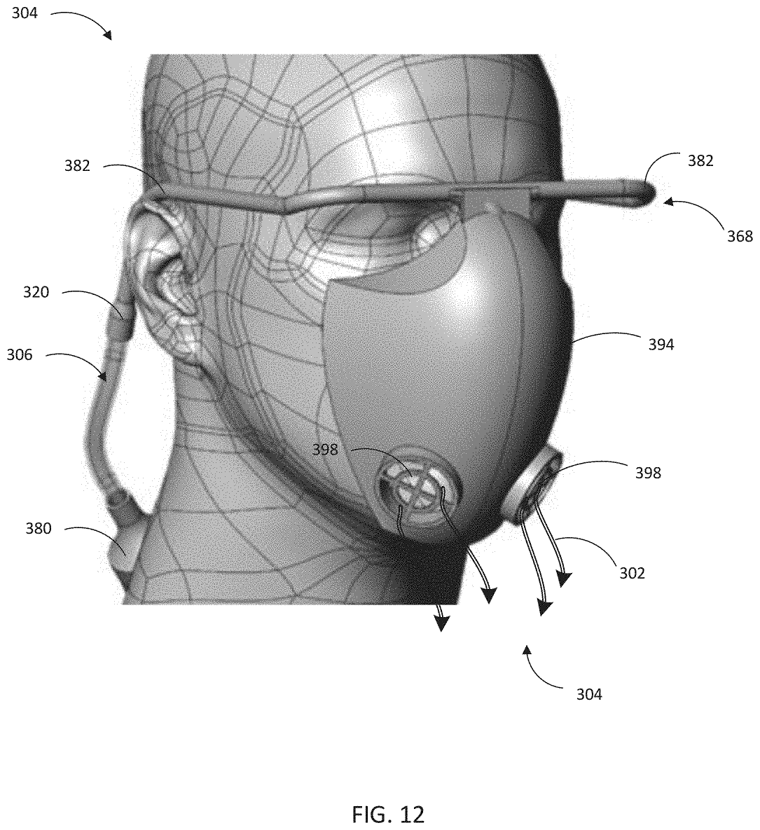

With reference to FIG. 12, the air cleaning device 300 may also include a detachable or integral mask 394. The mask 394 is configured to seal around and cover the nose and mouth of the user to ensure that the user breathes only the personalized airflow 302. Because the mask 394 seals onto the face of the user, the mask 394 includes one-way vents 398 that allow personalized air and exhaled breath to exit the mask 394. In some cases, the one-way vents 398 may be covered by a filter (not shown) to prevent any potential contaminants in the user's exhaled breath from exiting into the environment, where said contaminants could potentially harm others. Even so, in some cases, the pressure in the mask 394 may still become high enough to at least partially break the seal between the mask 394 and the face of the user. In this case, the positive pressure within the mask 394 causes air (e.g., personalized airflow and exhaled air) to flow out of the mask 394, thereby preventing contaminated air 304 from the environment from entering the personalized airflow 302 and ensuring that the user remains fully protected.

One skilled in the art may combine any of the aspects of the embodiments described above to optimize a device for a specific environment or set of operating conditions. For example, a device configured as a pair of eyewear similar to the air cleaning device 200 may only include a passive contaminant removal system similar to the air cleaning device 300 to improve battery life and reduce the costs associated with producing the device. Additionally, any of the above embodiments may include removable shields or mask portions to improve respiratory protection.

What is claimed is:

1. A personal airflow device, comprising:
an airflow inlet;
a first filter through which airflow from the airflow inlet passes;
an airflow outlet connected to receive the airflow from the first filter, and disposed within the airflow device such that, when the airflow device is worn on a user's head, the airflow outlet is proximate to the user's nose;
a first sensor configured to measure an attribute relating to the airflow;
a processor;
a memory in communication with the processor having instructions stored thereon which, when executed, cause the processor to:
receive a first signal from the first sensor indicative of an attribute relating to the airflow; and
in response to the first signal, send a second signal to a fan regulating the airflow through the airflow inlet, so as to adjust an envelope of filtered airflow created by the airflow outlet proximate to the user's nose,
wherein the airflow device comprising the airflow inlet, first filter, airflow outlet, first sensor, processor, and memory is configured to be worn about the head of a user.

2. The device of claim 1, further comprising a fan connected to provide the airflow to the airflow inlet.

3. The device of claim 2, wherein the fan is external to the airflow device, and comprises a conduit connecting the fan to the airflow inlet of the airflow device.

4. The device of claim 3, wherein the fan is configured to be worn by a user separately from the airflow device.

5. The device of claim 1, wherein the first sensor is a pressure sensor positioned to measure a pressure differential relative to the first filter.

6. The device of claim 2, wherein the instructions further cause the processor to receive a signal from a second sensor, the signal from the second sensor being indicative of an attribute of ambient air near the user.

7. The device of claim 6, wherein the second sensor is a contaminant sensor.

8. The device of claim 7, further comprising a wireless transceiver, and further wherein the second sensor is disposed external to the airflow device, and the signal from the second sensor is indicative of contaminant content of ambient air near the user.

9. The device of claim 6, further comprising a disinfection module disposed within the airflow device to receive filtered airflow from the first filter, and wherein the instructions further cause the processor to: receive a second signal from the second sensor indicative of contaminant content of the airflow; and in response to the second signal from the second sensor, adjust a setting of the disinfection module.

10. The device of claim 1, wherein the airflow outlet is configured to be seated over a user's nose bridge and distribute the envelope of filtered air downward over the user's nostrils and mouth.

11. The device of claim 10, wherein the instructions further cause the processor to determine, based on the first signal from the first sensor, a relative particulate content level of ambient air near the user and send the second signal to the fan to increase a flow rate of the envelope of filtered air and thereby dynamically increase the user's inhalation of filtered air as a percentage of total air inhalation relative to the particulate content level.

12. The device of claim 10, further comprising an ambient airflow sensor disposed on an outer surface of the airflow device, connected to send a third signal to the processor, the third signal from the ambient airflow sensor being indicative of ambient airflow rate near the user's head.

13. The device of claim 12, wherein the instructions further cause the processor to determine, based on the third signal from the ambient airflow sensor, a relative ambient airflow rate near the user and send a third signal to the fan to increase a flow rate of the envelope of filtered air and thereby dynamically increase the user's inhalation of filtered air as a percentage of total air inhalation.

14. The device of claim 1, wherein the airflow outlet comprises a pair of nozzles configured to shape and orient filtered airflow as an airshield over the user's nose and mouth.

15. The device of claim 14, wherein the second signal sent by the processor to the fan causes the fan to generate an airflow exiting the airflow outlet sufficient to displace contaminated air away from the user's breathing orifices such that the user inhales at least 50% filtered air.

16. A method for providing personalized airflow, comprising:
detecting a change in a characteristic of particle content of ambient air near a user;
in response to detecting the change, initiating an airflow passing through a filter of a device worn by a user yielding filtered airflow;
directing the filtered airflow out of an airflow outlet situated proximate a user's nose, so as to generate a shaped airshield over the user's nose and mouth; and
adjusting a rate of the filtered airflow such that the user inhales at least 50% filtered air.

17. The method of claim 16, wherein the rate of the filtered airflow is approximately 0.38 L/s.

18. The method of claim 16, wherein the characteristic of particle content of ambient air comprises at least one of: particulate matter content and a presence of bioaerosols.

19. The method of claim 18 further comprising, in response to a change in presence of bioaerosols, initiating a disinfection module to disinfect the filtered airflow.

20. A wearable device comprising:
a housing configured to be worn on a user's head;
an airflow inlet disposed at an exterior surface of the housing;
a fan creating a positive airflow to the airflow inlet;
a first filter positioned within the housing to receive airflow from the airflow inlet and allow the airflow to pass through the first filter;
a first pressure sensor positioned within the housing to measure a differential pressure across the first filter;
a contaminant sensor configured to detect bioaerosols within the filtered airflow from the first filter;
a disinfection module disposed within the housing to receive filtered airflow from the first filter;
an airflow outlet disposed at an exterior surface of the housing, comprising at least one nozzle configured to distribute an airflow shield over a user's nose and mouth when the housing is worn by the user;
an ambient conditions sensor configured to detect at least one condition of ambient airflow near the user's head when the housing is worn by the user; and
a processor coupled to a memory having software instructions stored thereon which cause the processor to:
increase fan speed in response to detecting a pressure drop over the first filter;
alert a user to replace the first filter when a persistent pressure drop over the first filter exceeds a threshold;
initiate the disinfection module in response to detection of bioaerosols by the contaminant sensor; and
adjust fan speed relative to ambient airflow near the user's head, to maintain a desired level of user inhalation of filtered air from the airflow outlet.
